(19) United States
(12) Patent Application Publication
(10) Pub. No.: US 2017/0337174 A1
(43) Pub. Date: Nov. 23, 2017

(54) WORD PROCESSOR CALCULATIONS AND SYNCHRONIZATION WITH SPREADSHEET

(71) Applicant: Jacques Nault, Moorea (PF)

(72) Inventor: Jacques Nault, Moorea (PF)

(21) Appl. No.: 15/593,966

(22) Filed: May 12, 2017

Related U.S. Application Data
(60) Provisional application No. 62/337,548, filed on May 17, 2016.

(51) Int. Cl. G06F 17/24

(52) U.S. Cl. CPC G06F 17/246; G06F 17/248

(57) ABSTRACT

A tool is herein provided to allow word processors the facility of custom formulas calculations and of automatically recalculating custom data structures elements in their open template that does not place restrictions on where data can be entered. A document using custom formulas with custom data structures being copied and pasted into a spreadsheet, this tool provides the capability of synchronizing the computed results in the spreadsheet with the computed results in the word processor document. The tool herein described may also convert a spreadsheet using formulas into a word processor document and synchronize the computed results in the word processor document with the computed results in the spreadsheet.

### FIELD OF THE INVENTION

The invention relates to word processing and more specifically to processes, methods and apparatuses for providing word processors the facility of calculations and of recalculating data in the open template, where the results changes automatically if the data is changed, and for synchronizing those results with spreadsheet software.

### BACKGROUND OF THE INVENTION

Existing spreadsheet software uses cells, rows and columns to hold data and is designed to automate the management of large amounts of numerical data and to apply calculations as required, whereas word processors use an open template that doesn't place restrictions on where data can be entered and are designed to process large amounts of text.

While spreadsheet software facilitates calculation and recalculation of data, where the result changes automatically if the data is changed, word processors facilitate the creation and editing of documents, but do not facilitate the calculation and automatic recalculation of data in the open template.

Both applications can create documents and it is therefore possible to use one to simulate the function of the other to some extent. For example, one can write whole paragraphs inside a single spreadsheet cell, or a text box, but formatting options of spreadsheet software are limited compared with word processors, which are primarily concerned with text and how this text appears on the page. Conversely, the font, paragraph, and page formatting options of word processors makes it easy to create documents, but is not designed to work with figures.

By way of another example, one may also insert tables and spreadsheet tables inside a word processor document, document such as annual reports comprising financial statements, but, in doing so, would lose the flexibility offered by the open template that doesn't place restrictions on where data can be entered.

Word processors calculations capabilities are limited to few basic calculations, and processing complex custom formulas to compute complex custom data structures elements is not possible.

What is needed, therefore, are techniques for allowing word processors to process complex custom formulas and to compute complex custom data structures directly in the open template that do not place restrictions on where the data can be entered, and if the computed results could be synchronized with spreadsheets.

### SUMMARY OF THE INVENTION

One object of the present invention is to provide a tool that can provide word processors the facility of complex custom formulas calculations and of automatic recalculating of complex custom data structures elements in an open template.

Another object of the present invention is to provide a tool that allows a user to copy & paste a document using complex custom formulas with complex custom data structures into a spreadsheet, as if it was originally created in the spreadsheet.

Yet another object of the present invention is to provide the capability of synchronizing the computed results in the spreadsheet with the computed results in the word processor document.

Also, another object of the present invention is to provide a tool which can copy a spreadsheet using complex custom formulas with complex custom data structures into a word processor document, as if it was originally created in the word processor document.

Yet another object of the present invention is to provide the capability of synchronizing the computed results in the word processor document with the computed results in the spreadsheet.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 illustrates a word processor document with custom formulas computed results shown within bookmarks brackets, and the list of bookmarks names made from the custom formulas;

FIG. 2 illustrates a spreadsheet with a copied & pasted word processor document and the list of names assigned to the spreadsheet cells;

FIG. 3 illustrates the replacement of the cells contents by the custom formulas made out of the names assigned to the spreadsheet cells;

FIG. 4 illustrates a spreadsheet with custom formulas computed results; and

FIG. 5 illustrates a word document with the copied cells contents of a spreadsheet using custom formulas, the word processor computed results being shown within bookmarks brackets, and the list of bookmarks names made from the custom formulas.

### DETAILED DESCRIPTION

A method providing word processors the facility of complex custom formulas calculations and of automatic recalculating of complex custom data structures elements directly in the open template that doesn't place restrictions on where data can be entered is herein described. This method uses the bookmark feature of word processors to put computed results, such as financial statement items, into a word processor document, such as an annual report.

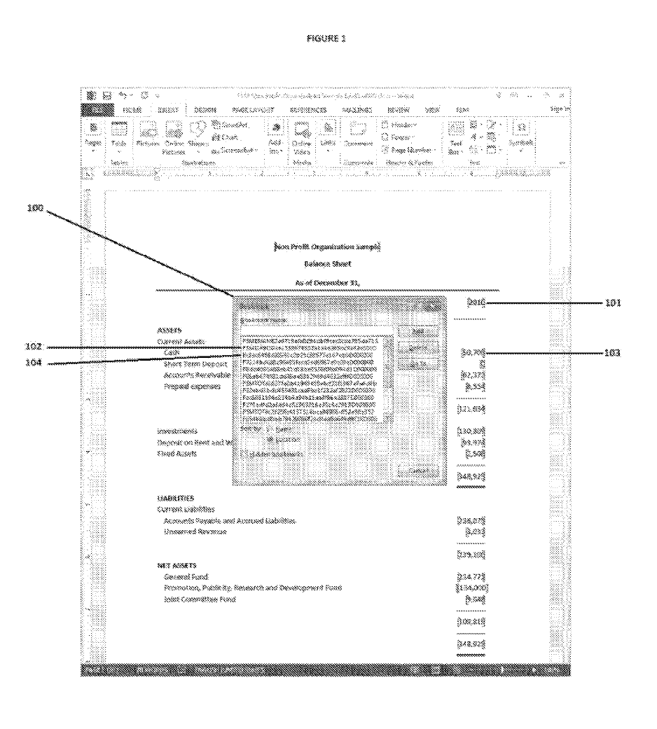

In a typical word processor, a bookmark identifies a location or a selection of text that may be named and otherwise identified for future reference. A bookmark may comprise a location, a text and a name. FIG. 1 shows a word processor document with the bookmark text being displayed between brackets. The list of bookmarks 100 list the bookmarks in the sequence they appear in the document. The bookmark text 101 is the result of the computation of the custom formula=FSMASOFDATE(“0”), custom formula from which the bookmark name 102 is made of, with the letters FSMDA, followed by the formula parameters, i.e., a unique index, then a period index (3 digits). This custom formula returns the value of the period index element of a data structure which is a list of dates.

The bookmark text 103 is the result of the computation of the custom formula=F SMITEMBALANCE(“c3ac6458-c909-40c2-b25c-38577e187eb0, D, 0, 0”), custom formula from which the bookmark name 104 is made of, with the letter F, followed by the formula parameters, i.e., a unique index, then the item sense (D or C), then the beginning period index (3 digits) and the ending period index (3 digits). This custom formula uses the parameters to select and compute elements of a trial balance data structure storing the accounts of the accounting data, which trial balance data structure elements of the trial balance data structure are linked with a doubly linked list of pointers thereby allowing manual grouping of the accounts from a user display into financial statement items using sub-lists of pointers, wherein each account has a computed account balance resulting from one or more transactions. The item sense parameter allows the computed result between parentheses to be presented when the accounting direction (Debit or Credit) of that result differs from the financial statement item accounting direction.

Not every country presents such result between parentheses, so the present invention, in embodiments, may initialize a number format string with the localized default for the maximum value for the positive section of the number format string and the localized default for the minimum value for the negative section of the number format string. In such an embodiment, if the currency format presents a negative amount between parentheses, the embodiment of the present invention may set the number format string to present negative amount between parentheses and use that number format string when it initializes the bookmark text with the computed result.

In other embodiments, when changes are made in the custom data structures elements, bookmark text is automatically updated by converting the bookmark names into the custom formulas and then computing those formulas.

Bookmark names being made from the custom formulas and their parameters, changing a custom formula parameter changes the bookmark name.

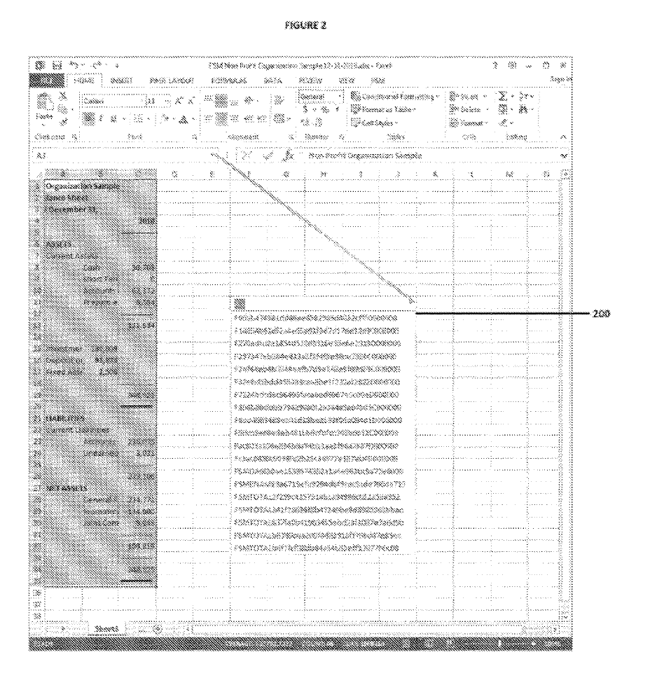

Performing a copy & paste from the word processor document to a spreadsheet workbook, the bookmark text and the bookmark names are copied into the spreadsheet. As shown in FIG. 2, in embodiments, the bookmark text is copied into cells and bookmark names are assigned as name to cells. The list of names 200, in embodiments, may list the names in alphabetical order.

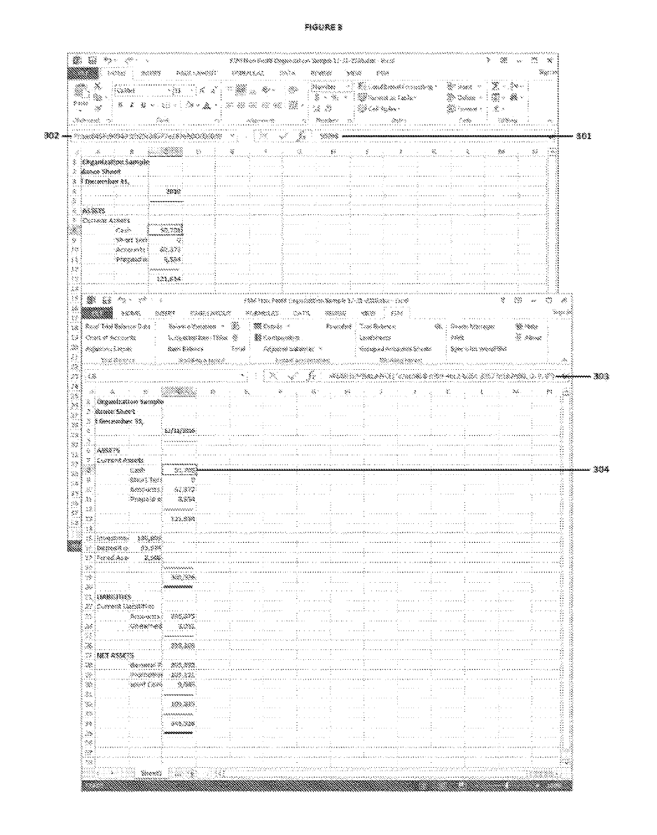

FIG. 3 shows the replacement of the cells' contents by the custom formulas, which are made out of the names assigned to the spreadsheet cells, in accordance with embodiments of the present invention. When using the same custom data structures and the same custom formulas in both software applications, i.e., in the word processor and in the spreadsheet software, wherein cells assigned names are made from the custom formulas used in the word processor, embodiments of the present invention can replace the contents of cells such as 301, having an assigned name 302, with the custom formula 303, and the computed result 304 is then displayed in the cell.

When using the same custom data structures, the same custom formulas, and the same unique index in the custom formula in both software applications, the unique index referring to the custom data structure elements computed, embodiments of the present invention can synchronize the computed results in the spreadsheet software with the computed results in the word processor. Changes made among the custom data structure elements computed in the word processor, such as adding/removing elements to/from the custom data structure, can be applied automatically in the spreadsheet.

In the word processor, the elements of the custom data structures are stored in files accessible without running the software, such as the document custom XML parts, wherein the parts identification is stored in document variables, and wherein the data of such custom XML parts is accessed by making a copy of the document, renaming that copy by adding the suffix ‘.zip’, opening the renamed copy and obtaining the data from the files.

(the above formulation “stored in files accessible without running the software, such as” is not intended to limit such embodiment to use with Microsoft Word, which new file format was introduced with Word 2007, dividing the file into document parts, each of which defines a part of the overall contents of the file. That file format consists of a compressed ZIP file, called a package. This package holds all of the content that is contained within the document.

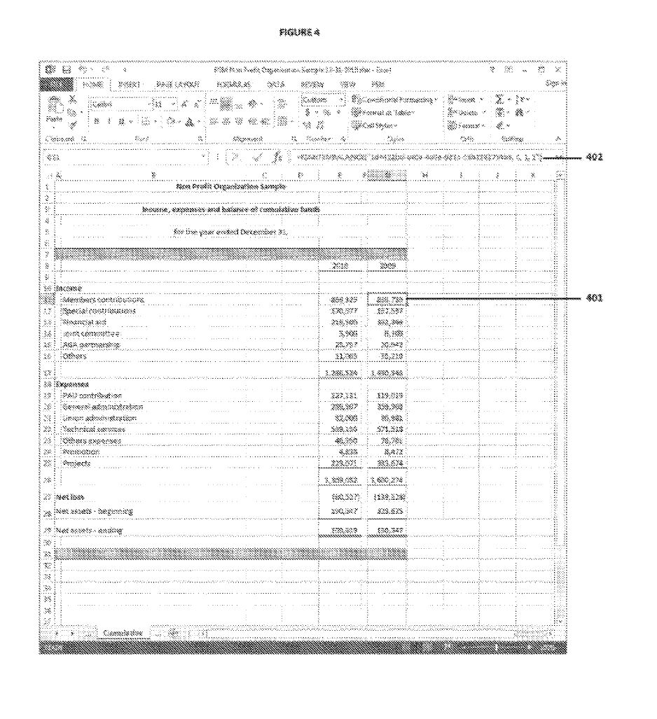

Further embodiments of the present invention are configured to allow automated conversion of a spreadsheet using formulas, as shown in FIG. 4, into a word processor document, by accessing the spreadsheet contents, then copying the contents of each cells into the document and automatically creating bookmarks when the copied cells 401 contain a formula 402, wherein the bookmark text is the result of the computation of the formula, formula from which the bookmark name is made with. Such embodiments do not place restrictions on where data can be entered.

As well as the main strength of word processors, i.e. their formatting capabilities (the manipulation of characters, paragraphs, pages, and documents) they allow for additional functions in the context of the present disclosure.

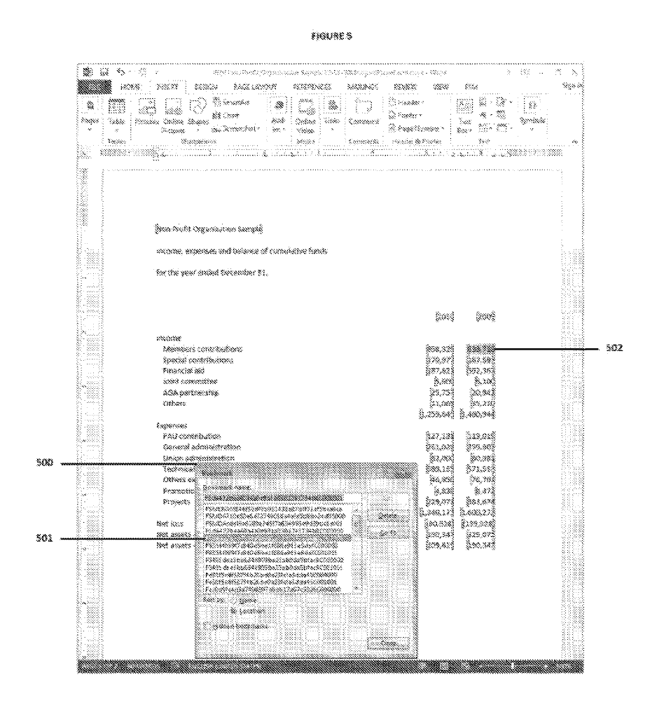

FIG. 5 shows a word processor document with the copied cells contents of the spreadsheet shown in FIG. 4, the bookmark text being displayed between brackets, in accordance with embodiments of the present invention. The list of bookmarks 500 list the bookmarks of the word document in the sequence they appear in the document. This embodiment of the present invention created the bookmarks for the cells containing a formula, with bookmark name 501 made from the formula 402 and its parameters, and with bookmark text 502 being the computed results of the formula.

When using the same custom data structures, the same custom formulas, and the same unique index in the custom formula in both software applications, i.e., in the word processor and in the spreadsheet software, which unique index refers to the custom data structure elements computed, the present invention can synchronize the computed results in the word processor document with the computed results in the spreadsheet. Changes made among the custom data structure elements computed in the spreadsheet, such as adding/removing elements to/from the custom data structure, can be applied automatically in the word processor document.

The foregoing description of the embodiments of the invention has been presented for the purposes of illustration and description. Each and every page of this submission, and all contents thereon, however characterized, identified, or numbered, is considered a substantive part of this application for all purposes, irrespective of form or placement within the application. This specification is not intended to be exhaustive or to limit the invention to the precise form disclosed. Many modifications and variations are possible in light of this disclosure.

What is claimed is:

1. A system for providing word processors the facility of complex custom formulas calculations and of automatic recalculating of complex custom data structures elements directly in the open template that doesn't place restrictions on where data can be entered;
wherein, the computed results can be synchronized with spreadsheets.

2. The system of claim 1, wherein a word processor document using complex custom formulas with complex custom data structures can be copied and pasted into a spreadsheet, as if it would have been originally created in the spreadsheet.

3. The system of claim 2, wherein the computed results in the spreadsheet can be synchronized with the computed results in the word processor document.

4. The system of claim 1, wherein a spreadsheet using complex custom formulas with complex custom data structures can be copied and pasted into a word processor document, as if it would have been originally created in the word processor document.

5. The system of claim 4, wherein the computed results in the word processor document can be synchronized with the computed results in the spreadsheet.

6. A computer-implemented method for providing word processors the facility of complex custom formulas calculations and of automatic recalculating of complex custom data structures elements directly in the open template that doesn't place restrictions on where data can be entered;
wherein, the computed results can be synchronized with spreadsheets.

7. The method of claim 6, wherein a word processor document using complex custom formulas with complex custom data structures can be copied and pasted into a spreadsheet, as if it would have been originally created in the spreadsheet.

8. The method of claim 7, wherein the computed results in the spreadsheet can be synchronized with the computed results in the word processor document.

9. The method of claim 6, wherein a spreadsheet using complex custom formulas with complex custom data structures can be copied and pasted into a word processor document, as if it would have been originally created in the word processor document.

10. The method of claim 9, wherein the computed results in the word processor document can be synchronized with the computed results in the spreadsheet.

11. A computer program product for providing word processors the facility of complex custom formulas calculations and of automatic recalculating of complex custom data structures elements directly in the open template that doesn't place wherein, the computed results can be synchronized with spreadsheets.

12. The computer program of claim 11, wherein a word processor document using complex custom formulas with complex custom data structures can be copied and pasted into a spreadsheet, as if it would have been originally created in the spreadsheet.

13. The computer program of claim 12, wherein the computed results in the spreadsheet can be synchronized with the computed results in the word processor document.

14. The computer program of claim 11, wherein a spreadsheet using complex custom formulas with complex custom data structures can be copied and pasted into a word processor document, as if it would have been originally created in the word processor document.

15. The computer program of claim 14, wherein the computed results in the word processor document can be synchronized with the computed results in the spreadsheet.
